(19) United States
(12) Patent Application Publication
(10) Pub. No.: US 2026/0050863 A1
(43) Pub. Date: Feb. 19, 2026

(54) WORK RELATED DATA CAPTURE PLATFORM WITH QUALITY GRADING

(71) Applicant: Primary Vector Inc., Seattle, WA (US)

(72) Inventors: Jonathan Soini, Seattle, WA (US); Tyler Axdorff, Seattle, WA (US); Daniel Roundhill, Missoula, MT (US)

(73) Assignee: Primary Vector Inc., Seattle, WA (US)

(21) Appl. No.: 19/299,075

(22) Filed: Aug. 13, 2025

Related U.S. Application Data
(60) Provisional application No. 63/683,043, filed on Aug. 14, 2024.

(51) Int. Cl. G06Q 10/0639

(52) U.S. Cl. CPC G06Q 10/06398

(57) ABSTRACT

A work-related data capture platform comprises inputting work-related data into a user interface by a user, wherein the work-related data corresponds to a task performed by the user, generating processed information from the work-related data, wherein the processed information comprises a determination of whether the task has been done acceptably. The platform further generates task review data as a subset of the processed information, provides the task review data to the user interface, letting the user know the task has been done acceptably or the task has not been done acceptably, and when the task has not been done acceptably, prompts the user, on the user interface, to correct errors and input additional work-related data providing evidence of the correction of the errors.

This patent application claims priority benefit of U.S. Provisional Patent application No. 63/683,043, filed on Aug. 14, 2024.

### FIELD OF THE INVENTION

This invention relates to data capture and processing platforms, especially for mobile devices, and more particularly to platforms that capture, merge, transform, and analyze multi-modal work-related data into structured, actionable information for quality grading.

### BACKGROUND OF THE INVENTION

Data collection workflows that rely on visual information have historically leveraged human input or imprecise optical character recognition, resulting in time-consuming processes prone to numerous errors. Existing solutions often require manual data entry, app development, or expose sensitive information to external parties (via ‘mechanical turk’ or ‘labelers’). These inefficiencies result in delayed business workflows, inconsistent data quality, and gaps in data collection. Moreover, current systems struggle to provide real-time, actionable insights from captured data, especially in environments with limited or no network connectivity.

Examples of workflows where current quality grading is incomplete or lacking, especially in real-time, include property management room inspections, store closing inspections, delivery confirmations, fleet vehicle inspections, law enforcement incident scene information collection, and a parent managing a child's school schedule. These workflow examples highlight the need for a data capture module that can guide users through appropriate workflows based on their role, location, and other relevant factors, and allow for quality grading of the workflow.

### SUMMARY OF INVENTION

In accordance with a first aspect, a work-related data capture platform comprises inputting work-related data into a user interface by a user, wherein the work-related data corresponds to a task performed by the user, generating processed information from the work-related data, wherein the processed information comprises a determination of whether the task has been done acceptably. The platform further generates task review data as a subset of the processed information, provides the task review data to the user interface, letting the user know the task has been done acceptably or the task has not been done acceptably, and when the task has not been done acceptably, prompts the user, on the user interface, to correct errors and input additional work-related data providing evidence of the correction of the errors.

From the foregoing disclosure and the following more detailed description of various embodiments it will be apparent to those skilled in the art that the present invention provides a significant advance in the technology of quality grading of workflows. Particularly significant in this regard is the potential the invention affords for providing quality grading of a workflow where the user inputs workflow data in response to prompts from the platform. Additional elements and advantages of various embodiments will be better understood in view of the detailed description provided below.

### BRIEF DESCRIPTION OF THE DRAWINGS

FIG. 1 shows a work-related data capture platform having a client application module/interface in accordance with one embodiment.

FIG. 2 is an embodiment of a workflow management module of the work-related data capture platform of FIG. 1.

FIG. 3 is an embodiment of a client-side interface of the work-related data capture platform of FIG. 1, with guided tasks.

FIG. 4 shows an example of client-side interface provided with feedback after completion of a task.

FIGS. 5-6 is an example of a task report visible to an administrator/scheduler of the work.

FIG. 7 is another example of the client-side interface showing a task follow-up.

It should be understood that the appended drawings are not necessarily to scale, presenting a somewhat simplified representation of various features illustrative of the basic principles of the invention. The specific design features of the work-related data capture platform as disclosed here, including, for example, the specific presentation of the client-side interface and administrative side interface, will be determined in part by the particular intended application and use environment. Certain features of the illustrated embodiments have been enlarged or distorted relative to others to help provide clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the work-related data capture platform disclosed here. The following detailed discussion of various alternate elements and embodiments will illustrate the general principles of the invention with reference to a work-related data capture platform especially useful for workflow where images about the work can be captured and quality grading can be introduced. Other embodiments suitable for other applications will be apparent to those skilled in the art given the benefit of this disclosure.

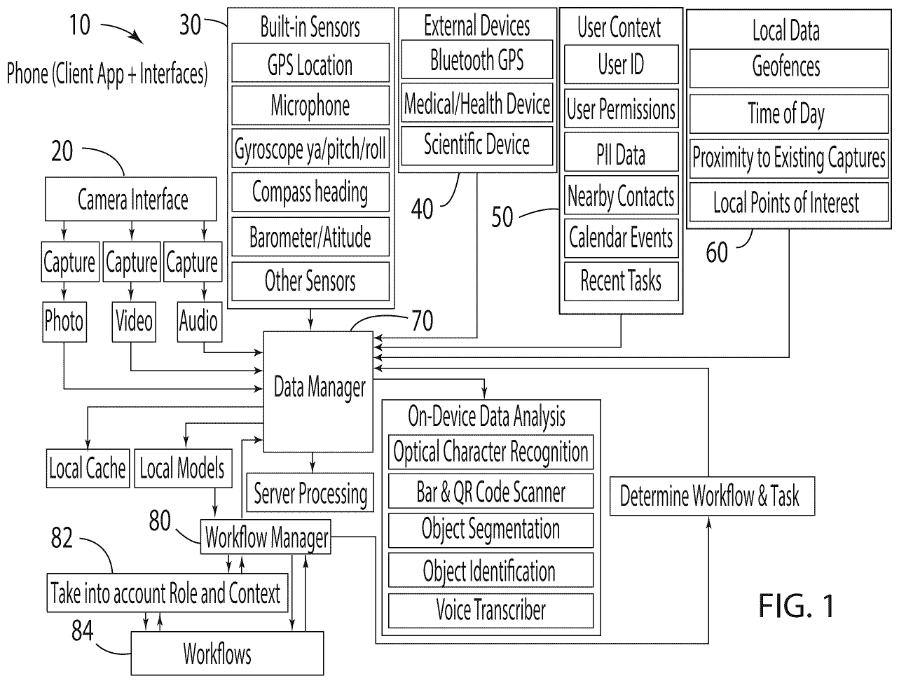

Turning now to the drawings, FIG. 1 shows a workflow/work-related data capture platform 10 with advanced on-device analytics and automated action execution. The platform typically comprises a mobile application with a user/client interface for capturing, merging, and analyzing diverse data types, and a cloud-based service for further processing, storing, and acting upon the captured information. This platform provides a significant advance in the technology of multi-modal data collection and processing, by not only capturing and analyzing workflow data but also to automatically initiate appropriate actions based on that workflow data, providing a material leap forward in productivity and efficiency. Particularly noteworthy is the potential the platform affords for reducing data collection and processing time, improving accuracy, and enabling more frequent and comprehensive data gathering and use across various industries, even in challenging network environments.

FIG. 1 shows a flow chart of the platform 10 in accordance with one embodiment. The user/client application interface captures and processes task/work-related data. The work-related data can be in one of several forms. A camera interface 20, typically the camera of a phone or tablet, is formed as a primary part of the user interface, and captures photo, video, and audio data about the task at hand. Audio messages are sendable by the user as part of the work-related data, and can be very useful to provide context to a photo sent by the user (also as part of the work-related data). Other work-related data inputs can be derived from built-in (to the phone/tablet) sensors 30, from external devices 40 operatively connected to the phone. Further, user context 50 and local data 60 can be considered and incorporated into the work-related data, as needed. The built-in sensors 30 allow for data collection from any one or more of a variety of sources, such as GPS location, a microphone, a gyroscope (for yaw/pitch/roll data), a compass heading, and a barometer/altimeter, or other sensors. External devices 40 which can transmit data to the platform can comprise, for example, Bluetooth GPS, Medical/Health Devices, and Scientific Devices. The User Context 50 can comprise important data about the user in the workflow/task, such as a user ID, user permissions, personal identifiable information (PII) data, nearby contacts, calendar events and recent tasks. Local data 60 can comprise, for example, geofences (a virtual geographic boundary, defined by software, that triggers an action when a mobile device enters or exits that area), a time of day, a proximity to existing captures, and local points of interest.

The collected work-related data from the camera interface, built-in sensors, external devices, user context, and local data is merged and processed by the data manager 70. The merged data is used for further processing and analysis. The data manager can also interact with a local cache to cache or retrieve data and with local models for on-device data processing. The work-related data processed by the data manager can be sent to a workflow manager 80, which determines and manages end-user/client-facing workflows. Example workflows comprise work-related data relating to any one of a property management room inspection, a store closing inspection, a delivery confirmation, a fleet vehicle inspection, a law enforcement incident scene information collection, and a parent managing a child's school schedule. Other workflows will be readily apparent to those skilled in the art given the benefit of this disclosure. The data manager and the workflow manager may split tasks in other ways than described here, as needed for more efficient process flow. The workflow manager 80 may also take into account various roles and contexts 82, such as time of day (such as evening), status of a store (retail), a role of the user (worker or manager), a location of a nearby store, a delivery driver role, an operations depot geofence, and/or an operations role, for example. The platform can send data for processing when online to server processing, which helps determine the appropriate workflow 84 and task based on the received work-related data. Optionally, the user may be prevented from transmitting work-related data in certain circumstances, such as by applying a geofence to the work-related data. This can be used for rental car returns, for example, such that work-related data (such as photos of the vehicle when it is returned) can only be transmitted by the user when the user is in a predetermined geographic boundary (at the rental car return). Location based alerts can be sent to the user, such as an indication that the user is now with a geofence where the platform is available to receive work-related data.

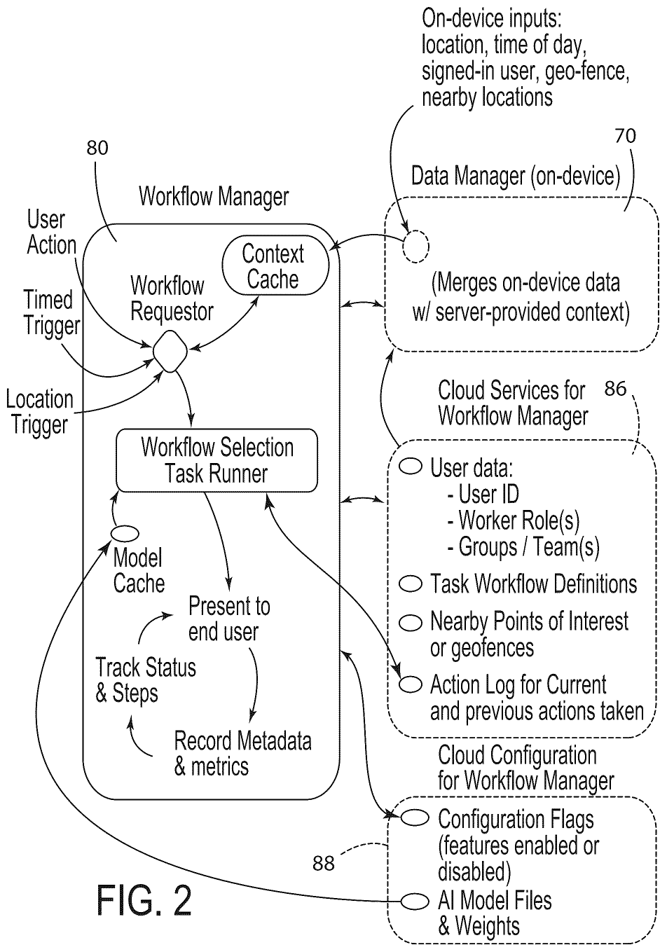

FIG. 2 illustrates an embodiment of a workflow manager 80 of the data capture platform which determines and offers suitable end-user-facing workflows within a mobile application. Examples of such workflows include, for example, ‘Quarterly Survey 1Q25’ or ‘Nightly Store Closing Inspection’. The process begins with a client application running on a mobile device, which includes the client application interface, local on-device models, and the data manager. The workflow manager receives various inputs, including: selection signals from the client application interface, and outputs from local on-device models. The workflow manager uses a workflow selection model to evaluate and determine appropriate workflows for the user. This model processes results and decides which workflows may run based on the current context and criteria. Within the workflow manager, specific tasks are performed, including, for example, taking inputs from the data manager 70, receiving combined data signals, running a workflow selection model to select a particular workflow, presenting a workflow to the client by displaying the selected workflows on the user/client interface, record selections and usage where user selection s and interactions are documented, and tracking workflow status. A cloud server/cloud services for workflow manager 86 is operatively connected with the workflow manager to provide additional context and criteria, such as user ID, roles (of the clients/users), groups, nearby locations, and a workflow list, and thereby enhance the decision-making process of the workflow manager. A cloud configuration for workflow manager 88 may also be used, providing configuration flags (indicating whether particular elements are enabled or disabled), as well as AI model files and weighting. A server database can record selections by the client and usage data for further analysis and enhancement. Interaction flow would typically comprises at least some of the following steps: receiving context from the server database (where the workflow manager receives context data from the cloud server), processing local model outputs (where local on-device models process data outputs), presenting workflows to client (where selected workflows are presented to the client, such as task review data and other feedback to the client after the client has indicated a task has been completed), recording selections and usage (where user selections and usage data are recorded), tracking workflow status, and storing data in the server database for future reference and analysis.

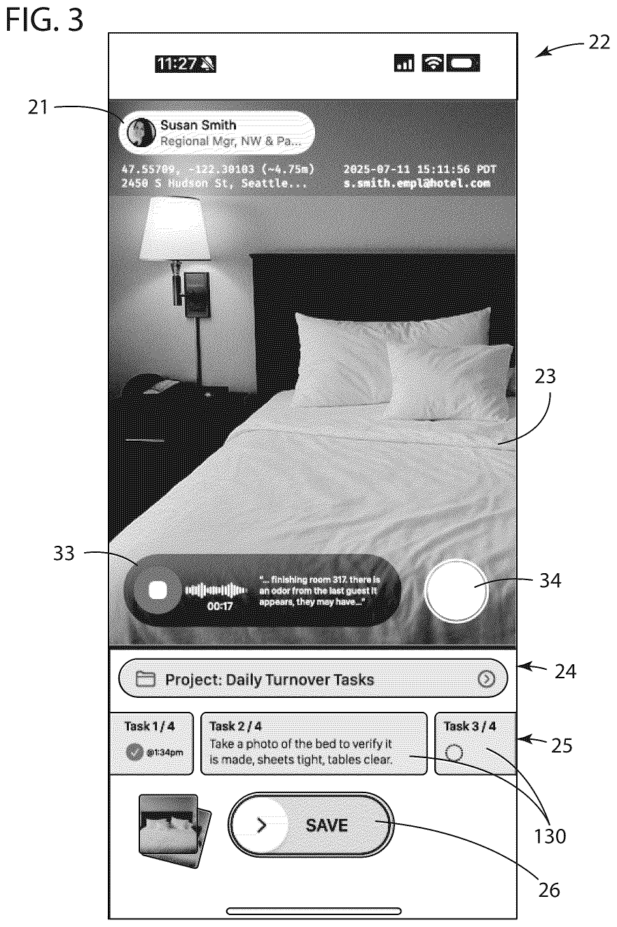

FIG. 3 illustrates an embodiment of the client view interface 22. Several features are presented, including worker ID 21, as well as other identification markers, such as an indication of the task at hand, a view 23 such a live view of the area where a task is to be performed, a voice recognition element 33, a capture button 34 (for capturing images), a project picker 24 (which refers to a user interface component, often a date or file picker, that allows users to select a date or file from a predefined set of options or by interacting with a visual element like a calendar or file upload area), a task management window 25, an indication of task name 130, and a way to indicate the task has been completed (or an image is ready for capture and uploading) such as save button 26. Once the user and the task has been identified, the user performs the task. In accordance with a highly advantageous element, the work-related data is not only captured, but the platform provides prompts to specify to a worker the particular set of work-related data required. The platform guides the user to provide the necessary work-related data, and can signal when the work-related data has been provided to meet a necessary threshold (acceptable/unacceptable). This can comprise, for example, requiring the worker to take one or more images specified by the platform using the phone, and uploading these images as evidence the task has been completed. The platform automatically uploads all data once the capture session is completed. The data manager can confirm whether all of the work-related data has been received from the user, and provide indication that all of the work-related data has been received to the user interface. Optionally users can save all work-related data once finished, but can also add additional captures to the current session.

Looking at the prompt based or guided capture feature of the client application interface in more detail, it is noted that this feature changes how users capture and document sequential photographic information by guiding them through predefined steps to capture images in a specific order, ensuring comprehensive and standardized documentation of various tasks and processes. The feature incorporates real-time image analysis for quality control and intelligent project recommendations based on user context and preferences. The prompt based/guided capture feature disclosed herein also includes intelligent and automatic project selection, which can be based on several factors, including the user's location, the user's profile, the user's past usage, geo-fencing, time of day, and even image recognition in the viewfinder.

The guided capture feature provides a structured and intuitive framework for capturing sequential photographic information. The feature can consist of the following key components: project creation—an administrator can create projects by defining a sequence of steps, each representing a specific photo to be captured. Steps can be configured to require a single photo or multiple photos, step configuration—each step can be configured with detailed instructions, including the required image content, framing, and any relevant metadata (steps can be designated as required or optional, and quality gates can be set to ensure that captured images meet specific criteria), project library-a library of predefined projects will be available for common use cases, such as product documentation, rental car returns, and property inspections, etc., (users can also share and import projects), project selection-users can select a project from the library or create a new one before initiating the capture process (the application can also automatically select a project based on various factors, including the user's location, user profile, past usage, proximity to geo-fenced areas, time of day, and objects or scenes detected in the live camera feed), step-by-step guidance—the application can provide a series of prompts to guide users through each step of the selected project, providing clear instructions and visual cues on the camera interface, such as overlays or highlights to indicate the required framing or content of the photo, real-time image analysis-after each photo is captured, the app will analyze the image in real-time to assess its quality and relevance to the current step (the analysis can consider factors such as image sharpness, focus, lighting, and the presence of specific objects or features. If the image does not meet the predefined criteria, the user will be prompted to retake the photo), progress tracking—the app will display the user's progress through the project, indicating the current step, the number of remaining steps, and the status of each step (e.g., completed, pending, or requires retake).

Other key components of the prompt-based work-related data capture platform can comprise, for example, photo review-users can review captured photos within the project flow, with the ability to navigate between steps and retake photos, if necessary, make intelligent project recommendations, provide contextual awareness, where contextual signals can be leveraged to suggest relevant projects. These signals may include a user's location using GPS or other location services to determine the user's current location and suggest projects relevant to that location, time of day—taking into account the time of day to suggest projects that are typically performed at specific times, user profile—considering the user's profile information, such as occupation or interests, to suggest projects that align with their needs (e.g., a “Product Documentation” project for marketing professionals), previous usage-analyzing the user's past project selections to recommend projects they are likely to use again, geo-fencing—triggering specific projects when the user enters a predefined geographical area, image recognition—the app will analyze the live camera feed to identify objects and scenes, using this information to suggest appropriate projects, and user feedback—where the application will learn from user interactions and feedback to refine project recommendations over time. This could involve tracking which suggested projects users accept or reject, as well as collecting explicit feedback through surveys or ratings.

As noted above the user/client interface is typically a mobile device that collects and uploads various types of work-related data, including multimedia, sensor data, and contextual information. Such work-related data is first processed through preprocessing nodes, which perform at least the following: acknowledgment (confirming receipt of the work-related data back to the client application), validity check (verifying that the data is valid and usable), database & blob storage (storing work-related data in appropriate databases), map application programming interface (performing location lookups based on the work-related data), nearby items & context (checking for recent or relevant items nearby in terms of location and time), content safety check (canning the content for NSFW material), and audio transcription (transcribing audio data and analyzing tone and emotions via tone & emotion buckets. Work-related data deemed valid and safe is sent to a primary processing node, which executes high-level processing tasks, such as: scene summary (generating a summary of the scene/image from the work-related data), tools coordinator (sending the summary and context to the tools coordinator). A tools coordinator can be provided which includes several components, what you see is what you get (WYSIWIG) tool creator, which enables the creation of tools through a WYSIWIG interface, tool output ranking which ranks the outputs of different tools, a tool eligibility ruleset which applies rules to determine tool eligibility and a tool chooser model which selects appropriate tools based on the context.

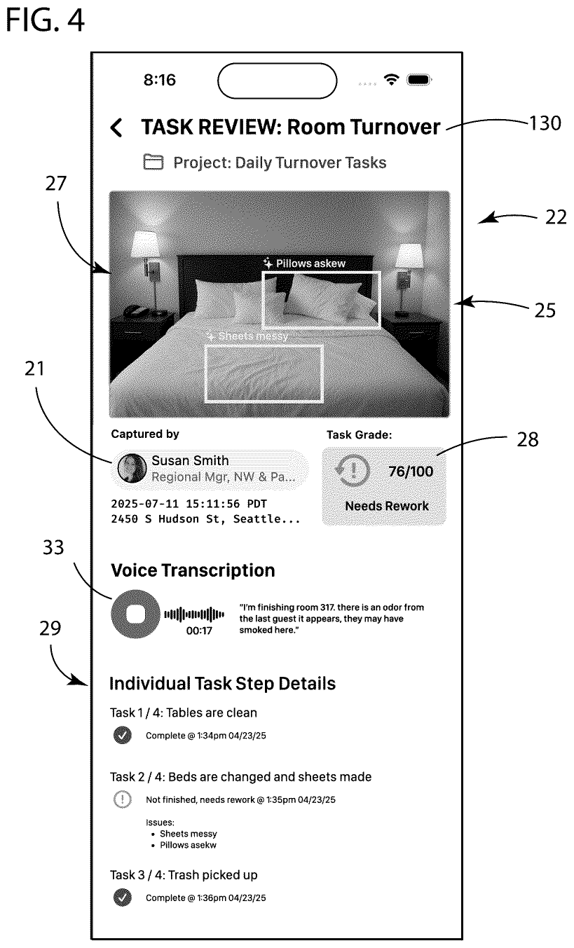

FIG. 4 illustrates an embodiment of shows an example of client-side interface 22 provided with feedback after completion of a task. Worker ID 21, as well as other identification markers are provided. An indication of task name 130 and the task management window 25 can be provided. The task management window can provide a view based on the photos provided as work-related data. The processed information developed by the input of the work-related data into the data manager is used to create task review data for delivery to the user/client interface at task management window 25. That is, the task review data can comprise at least some of the photos from the work-related data (supplied by the user) marked up to indicate deficiencies preventing acceptance. In the embodiment of FIG. 4, the task review data indicates a pair of errors or issues and marks them on the photo 27 provided by the client as shown. The task management window may also provide an indication that the work done was acceptable when the photos, videos and/or other work-related data is supplied to the data manager by the worker, and compared to a reference standard of acceptable work. The client interface may also be provided with the voice recognition element 33, display of a task grade 28, and a display of individual task details 29, which can display how portions of the task have been completed or not completed successfully. The worker has the option to supply new or further work-related data, such as images indicating the deficiencies in the task which were highlighted in the task review data have been rectified. That is, the platform can prompt the user, on the user interface, to correct errors and input additional work-related data providing evidence of the correction of the errors. The process would then repeat. In this situation, the data manager would compare the additional work-related data against the acceptable standard, (such as by comparing photographs taken by the user) to confirm the additional work-related data matches or is in conformity to the acceptable standard, and then send a message to the user interface indicating the task has been completed in an acceptable manner.

Work-related data, along with reference data, is used to create processed information. The processed information includes task review data which can be rapidly displayed on the user/client interface 22. The processed information comprises a determination of whether the task has been done acceptably. The platform disclosed herein advantageously supports real-time processing and feedback, allowing users and administrators to see essentially immediate results of the actions taken by the platform. This includes real-time recognition of objects, text, and other data, enabling quick and efficient management of captured information, such as prompting the worker to address a task that is not fully completed or acceptably completed. The task grade may be calculated by, for example, based on a written criteria as entered in the platform by an administrator. For a given task, that can mean: individual items of each task are graded, such as comparing photos supplied by the user that the bed is made, are the pillows fluffed and orderly, and are the sheets pulled taut to the written criteria/standard, and each individual item may be assigned a score (pass/fail, 1-5, or good/bad/etc. The platform can add scores up for several different items to create an overall score. The overall score may then be used to determine an overall grade or pass-fail, such as: given a particular task or item, is the room acceptable for guests? In additional, any particular item in the workflow that is graded too low (below a threshold) can cause all of the work to be graded as a ‘fail’, (e.g., an object is found in the room, or damage is found).

The work-related data capture platform disclosed herein can be used in a variety of areas, typically where pictorial or video recording of completion of a task can be compared to a standard, whether a written standard or photographic standard, and feedback to the client after completion of the task (about whether the work done was up to the standard or not) may be sent to the client interface. Examples comprise hospitality (Short-Term Rental Management), where a short-term rental management company wants its cleaning workers to document the condition of properties before and after cleaning. Guided capture projects would guide workers through capturing photos of each room or major area, ensuring a consistent and thorough record for quality control and dispute resolution. Another example is in retail, where a retail company can create tasks to guide workers in capturing product photos for inventory management or marketing purposes. For example, a project could guide employees through capturing photos of a product's packaging, label, and shelf display. Insurance is another area where this platform can be used, as insurance adjusters can use guided projects/prompts to document property damage systematically, ensuring all necessary details are captured for claims processing. The platform can guide adjusters through capturing photos of the exterior and interior of a damaged property, as well as close-ups of specific areas of damage. Another area suitable for use of this platform is security, where security workers can use platform generated prompts/guided projects to document patrols and inspections, providing a visual record for security and liability purposes. A project could guide security guards through capturing photos of specific checkpoints, entrances, and exits during a patrol. In addition, the platform may be used in construction, such as having construction managers/administrators use prompts/guided projects to document the progress of a workflow/task at various stages. The platform can guide workers through capturing photos of the site before, during, and after each phase of construction.

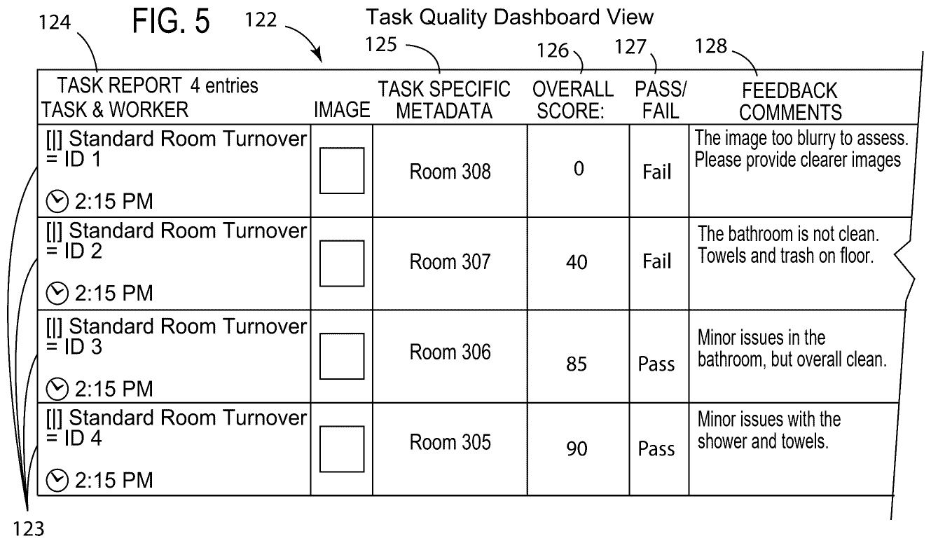

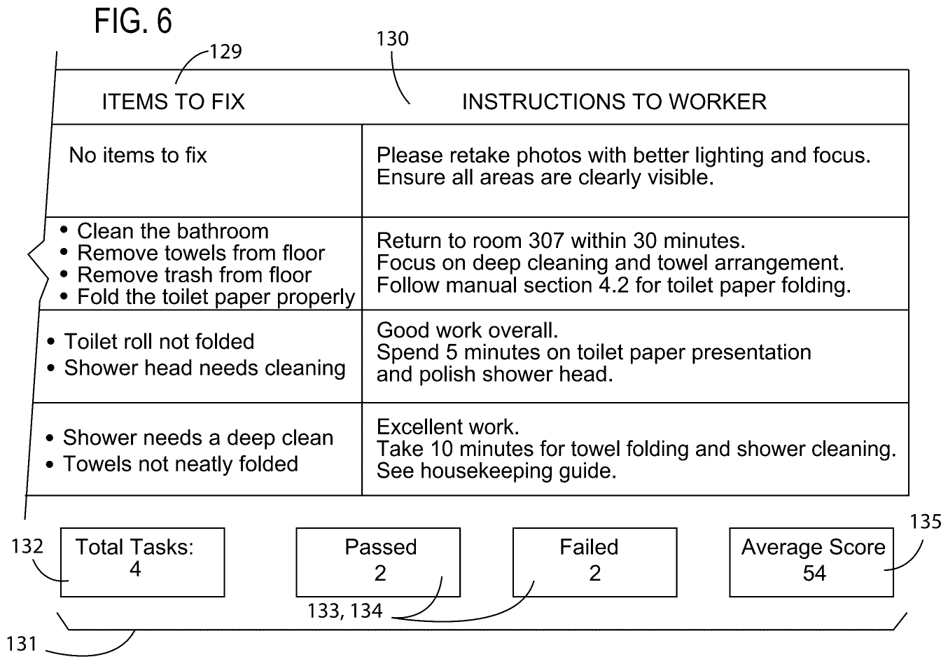

FIGS. 5 and 6 show a task quality dashboard view 122 of administrative data on an administrative interface. Such administrative data can be viewed by administrators of the platform or their duly authorized agents. The administrative data is part of the processed information created by the data manager, and can track work done by many users/workers, and at different times. The task quality dashboard view advantageously allows for viewing of many workers essentially simultaneously and/or essentially in real-time. This advantageously allows for rapid feedback when time is of the essence in completing a task. In the embodiment of FIG. 5, a task report 124 is produced having a series of entries 123 for each worker, typically workers performing similar or identical tasks. A link to the work-related images provided by each worker may be provided, along with a task specific metadata 125 about the particular task of the particular worker, such as a room number. The graded score 126 for the task completed by each worker may be shown, along with a binary Pass/Fail notice 127. Feedback/Comments 128 may be listed (and of course may also be displayed on the client/user interface as part of the display of task details. FIG. 6 can show additional details about each task, such as tasks/items to fix 129 (to complete the task), as well as any instructions to the worker 130 (which can also be displayed on the client/user interface.

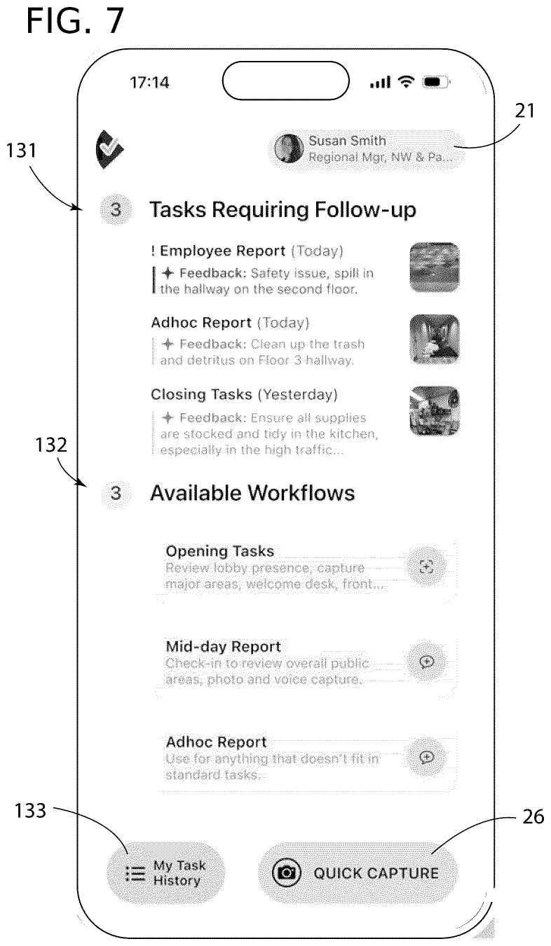

FIG. 7 shows another embodiment of the client-side interface 22 showing a worker receiving task follow up instructions. Automatically suggesting which tasks need to be corrected/fixed is a highly advantageous element which gives immediate feedback to the worker to correct any items of a task which have not been done correctly/acceptably. Client ID 21 can be presented, along with a list of tasks requiring follow up 131. The tasks can be broken up into individual items/subtasks, and deficiencies in individual items or in the overall task may be displayed as text and/or photos. Tasks may be regularly scheduled or on as needed basis. For example, room cleaning may be regularly scheduled in advance, but as shown a spill in the hallway may require attention on an irregular basis. Both kinds of tasks may be displayed in the tasks requiring follow up section 131. Tasks requiring follow up may be cumulative or present tasks which were not previously corrected. Available workflows 132 may also be displayed. These can be, for example, a list of tasks to be done, a daily or a mid-day report (which can also provide updates on tasks), and an ad hoc report, for special events and tasks that are not regularly scheduled. Optionally a task history button 133 may be provided to allow the user to see previous tasks and their completion. The quick capture/save button 26 is again provided so the user can take photos to upload to the platform to confirm correction/completion of outstanding tasks/items.

From the foregoing disclosure and detailed description of certain embodiments, it will be apparent that various modifications, additions, and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A work-related data capture platform comprises, in combination, the steps of:
inputting work-related data into a user interface by a user, wherein the work-related data corresponds to a task performed by the user;
generating processed information from the work-related data, wherein the processed information comprises a determination of whether the task has been done acceptably;
generating task review data as a subset of the processed information;
providing the task review data to the user interface, letting the user know the task has been done acceptably or the task has not been done acceptably; and
when the task has not been done acceptably, prompting the user, on the user interface, to correct errors and input additional work-related data providing evidence of the correction of the errors.

2. The work-related data of claim 1 further comprising the steps of:
confirming whether all of the work-related data has been received from the user, and
providing indication to the user interface that all of the work-related data has been received.

3. The work-related data of claim 1 wherein the processed information about the work-related data comprises quality grading of the work-related data, and the quality grading is part of the task review data sent to the user interface.

4. The work-related data capture platform of claim 1 further comprising the steps of:
creating administrative data from the processed information, and
displaying the administrative data on an administrator interface.

5. The work-related data capture platform of claim 4 wherein the administrative data comprises work-related data from multiple users and at multiple times.

6. The work-related data capture platform of claim 4 further comprising displaying a task quality dashboard view at the administrator interface which displays administrative data in real time.

7. The work-related data capture platform of claim 1 wherein the work-related data comprises at least one of photos, videos, text, and audio messages and the client interface is a mobile phone.

8. The work-related data capture platform of claim 7 wherein an audio messages is sendable by the user as part of the work-related data.

9. The work-related data capture platform of claim 1 wherein the work-related data comprises data relating to at least one of a property management room inspection, a store closing inspection, a delivery confirmation, a fleet vehicle inspection, a law enforcement incident scene information collection, and a parent managing a child's school schedule.

10. The work-related data capture platform of claim 1 wherein a task management window is delivered to the user interface, and the task management window indicates whether the task has been performed acceptably or not.

11. The work-related data capture platform of claim 10 wherein the work-related data comprises photos, and the task review data supplied to the user interface comprises at least some of the photos from the work-related data marked up to indicate deficiencies preventing acceptance.

12. The work-related data capture platform of claim 1 wherein the task review data is supplied to the user interface in real time.

13. The work-related data capture platform of claim 1 further comprising the step of applying a geofence to the work-related data, such that work-related data can only be transmitted by the user when the user is in a predetermined geographic boundary.

14. The work-related data capture platform of claim 1 further comprising the step of sending an alert to the user interface.
